(19) United States
(12) Patent Application Publication
(10) Pub. No.: US 2019/0228634 A1
(43) Pub. Date: Jul. 25, 2019

(54) Surface Water Sport Monitoring System for Improving Driver Awareness

(71) Applicants: Robert Bosch LLC, Broadview, IL (US); Robert Bosch GmbH, Stuttgart (DE)

(72) Inventor: James Page, Novi, MI (US)

(21) Appl. No.: 16/246,019

(22) Filed: Jan. 11, 2019

Related U.S. Application Data
(60) Provisional application No. 62/620,128, filed on Jan. 22, 2018.

(51) Int. Cl. G08B 21/08; B63B 35/81; H04N 7/18

(52) U.S. Cl. CPC G08B 21/084; B63B 2201/26; H04N 7/183; B63B 35/81

(57) ABSTRACT

A monitoring system for use in a recreational watercraft operable to improve driver awareness of a surface rider engaged in a surface water sport supported by the watercraft. The surface rider may be towed by the watercraft or riding a wake provided by the vehicle. Sensors monitor the conditions of the surface rider and a processor analyzes the sensor data to generate feedback indicating status conditions to the driver. Multimodal feedback may be achieved using a plurality of feedback indicators having different modes of operation.

### TECHNICAL FIELD

This disclosure relates to the safe operation of recreational watercraft. In particular, this disclosure relates to the operation of a recreational watercraft when towing or providing wake for a rider on the surface of the water.

### BACKGROUND

Surface water sports may utilize a motorized leading watercraft to provide propulsion of a surface rider or a wake for the surface rider to maneuver on a body of water. Propulsion may be provided using a towline or a tow bar to the rider on a water-skimming device such as a wakeboard or water skis, or to a barefoot water skier. Wakes may be provided to surface riders performing non-towed surface water sports, such as wake surfing.

Drivers of the leading watercraft for the surface rider must be aware of the rider who is typically behind the watercraft while also maintaining attention to what is in front of the watercraft to avoid unsafe waters or collisions. Conventional arrangements rely upon a third person to act as a spotter to manually monitor the status of the surface rider and report when the surface rider has fallen. Additionally, the spotter may rely commands to the driver indicated by hand signals of the surface rider.

It is therefore desirable that a system may be able to the improve driver's awareness of the surface rider's status while minimizing the need for spotters and without averting the driver's attention from the forward motion of the watercraft. Such a system may improve safety for the surface rider, the watercraft, the driver and other passengers of the watercraft, and other vessels traversing the body of water.

### SUMMARY

One aspect of this disclosure is directed to a system for monitoring the status of a surface rider engaged in a surface water sport supported by a lead watercraft, the system comprising a number of sensors for monitoring the surface rider, a processor for interpreting the sensor data, and a plurality of feedback indicators to provide feedback to a driver of the watercraft about the sensor data. The number of sensors may comprise a camera, and the plurality of feedback indicators may comprise a display operable for the driver to visually monitor the status of the surface rider. In some embodiments, the number of sensors may comprise additional sensors, such as lidar or infrared sensors.

Another aspect of this disclosure is directed to a watercraft having a system for monitoring a surface rider utilizing the watercraft for propulsion or wake. The watercraft may comprise a hull, an aquatic motor, a helm operable to steer the hull toward a desired direction, a number of sensors operable to monitor the surface rider, a processor to interpret the sensor data, and a plurality of feedback indicators operable to provide indication of the sensor data. In some embodiments of the aspect, the watercraft may further comprise a towing attachment such as a towing hitch or a towing pylon.

In another aspect of this disclosure, a system for monitoring a surface rider from a watercraft may comprise a number of sensors, a processor to interpret sensor data, and a plurality of feedback indicators operable to provide indication of the sensor data. In one embodiment of this aspect, the plurality of sensors may include at least a display.

The above aspects of this disclosure and other aspects will be explained in greater detail below with reference to the attached drawings.

### BRIEF DESCRIPTION OF THE DRAWINGS

FIG. 1 is an illustration of a watercraft having a surface rider monitoring system

FIG. 2 is a diagrammatic overhead view of a watercraft having a plurality of sensors and illustrating the range of operations of a camera.

FIG. 3 is an illustration of a set of helm controls for a watercraft having a surface rider monitoring system.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

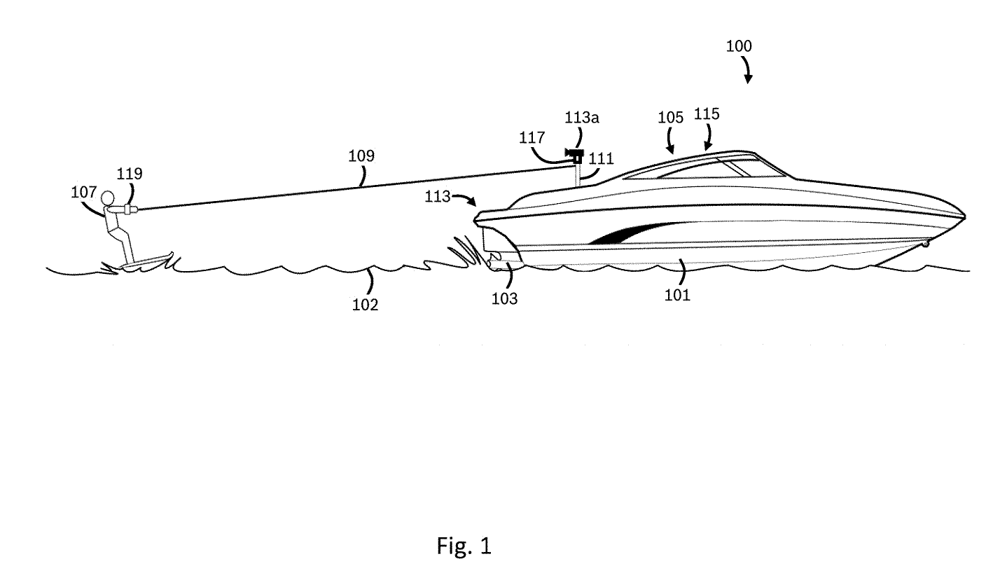

FIG. 1 shows a watercraft 100 having a surface-rider monitoring system according to an embodiment disclosed in the teachings herein. Watercraft 100 comprises a hull 101 operable to float up the surface 102 of a body of water. An aquatic motor 103 operably coupled to hull 101 may propel watercraft 100 across surface 102. The depicted embodiment, watercraft 100 comprises a recreational motorboat, but other embodiments may comprise other configurations of watercraft suitable for supporting a surface-rider in a surface water sport. In the depicted embodiment, the body of water may comprise a lake, ocean, river, or any other suitable body of water for supporting surface water sport activities.

The motion of watercraft 100 may be controlled by a driver (not shown) operating a helm 105. Helm 105 is operable to steer watercraft 100 toward a desired direction during motion of the watercraft. In some embodiments, the driver is oriented toward the bow of watercraft 100 when operating the helm 105 for safe navigation and maneuvering of the watercraft 100. A surface rider 107 may be supported by watercraft 100. In the depicted embodiment, surface rider 107 comprises a water skier using a towline 109, but other embodiments may comprise surface riders engaged in other activities such as discing, saucering, towed surfing, towed hydrofoiling, tubing, wakeboarding, barefoot water skiing, aquaplaning, water skurfing, kneeboarding or any other known towed surface water sport without deviating from the teachings disclosed herein. In some embodiments, surface rider 107 may be engaged in activities that do not require a towline 109, such as wake surfing, wake skating, or any other surface water sport not utilizing a towline known to one of ordinary skill without deviating from the teachings disclosed herein. Some embodiments may comprise a towbar disposed along the starboard or port of hull 101 instead of, or in addition to, towline 109. Towbar embodiments may be advantageous for inexperienced or student surface riders 107.

Towline 109 may be operably fastened to a towing attachment 111. In the depicted embodiment, towing attachment 111 comprises a towing pylon operably coupled to hull 101, but other embodiments may comprise a towing hitch, a towing splice, or any other equivalent embodiment known to one of ordinary skill in the art. In some embodiments not utilizing a towline 109, watercraft 100 may not comprise a towing attachment 111.

A number of sensors 113 may be operably disposed within proximity of the hull 101 that are operable to monitor the status of surface rider 107. Each of sensors 113 may be operable to generate surface-rider data corresponding to the current status of surface rider 107. Surface-rider data may correspond to the activity status of surface rider 107, such as when the surface rider 107 is successfully maintaining an active traversal of water surface 102 or if the surface rider 107 has fallen (often referred to as “down” or “wiping out”). The sensors 113 may further be operable to detect other conditions of the surface rider 107 with respect to water surface 102, such as performance of a stunt or trick such as a jump. Sensors 113 may further be operable to measure metrics of surface rider 107, such as the surface rider's proximity to watercraft 100, active bearing in relation to watercraft 100, active velocity in relation to watercraft 100, changes in active bearing or active velocity of surface rider 107. Sensor data may be received by a processor 115 and analyzed to determine the conditions of surface rider 107. In the depicted embodiment, processor 115 is disposed within the helm 105, but other embodiments may comprise other configurations without deviating from the teachings disclosed herein.

In the depicted embodiment, a number of the sensors 113 are disposed within hull 101, as part of the construction of watercraft 100, but other embodiments may comprise other configurations, such as operable coupling to hull 101, operable coupling to another structural element of watercraft 100 (e.g., ribs, bulkhead, etc.), or operable coupling to other components that are themselves operably coupled to watercraft 100, such as towing attachment 111 or another component of watercraft 100. In some embodiments, sensors 113 may be disposed on the exterior of hull 101, or affixed using cabling, ropes, or any other forms of operable coupling known to one of ordinary skill in the art without deviating from the teachings disclosed herein. In the depicted embodiment, sensors 113 may comprise infrared sensors, but other embodiments may comprise optical sensors, ultraviolet sensors, radar sensors, lidar sensors, laser detection sensors, sonic sensors, ultrasound sensors, cameras or any other form of sensors known to one of ordinary skill in the art without deviating from the teachings disclosed herein.

In some embodiments, sensors 113 may be in the form of a tension sensor or load sensor disposed such that they are within operable contact of a towing component of watercraft 100, such as disposed within towing attachment 111, or within the length or handle of towline 109. In such embodiments, tension or load sensors 113 may be operable to detect changes in the forces that towline 109 applies to watercraft 100. For example, if surface rider 107 goes down and releases towline 109, towline 109 is expected to experience a sudden large drop in tension.

In the depicted embodiment, one particular sensor 113 comprises a camera 113a operable to generate video data of surface rider 107. Camera 113a may be in wired or wireless communication with processor 115. Processor 115 may be operable to analyze the video data to generate corresponding surface-rider data. In the depicted embodiment, camera 113a is disposed upon towing attachment 111 and in wireless communication with processor 115, but other embodiments may comprise other arrangements without deviating from the teachings disclosed herein.

In some embodiments, processor 115 may be operable to detect and analyze gestures or hand signals made by the surface rider 107 in the video data collected by camera 113a. Gestures and hand signals may be utilized by the rider to indicate their status or provide direction to the driver of watercraft 100. Common gestures or hand signals may include a request to change speed, an indication of an intent to perform a stunt such as a jump, an indication that surface rider 107 intends to change relative position with respect to watercraft 100, or any other command desirable for a surface rider 107 and known to one of ordinary skill in the art.

Camera 113a may be advantageously operable to adjust the center-point of its field-of-view for the purpose of tracking a surface rider. Adjustment of the field-of-view may advantageously permit the camera 113a to provide usable video data and surface-rider data to processor 115 corresponding to a surface rider 107, even if the surface rider 107 changes relative position with respect to the watercraft 100. In the depicted embodiment, adjustment of camera 113a may achieved using a swivel mechanism 117. In the depicted embodiment, swivel mechanism 117 comprises motorized adjustment mechanisms that are controlled by processor 115 based upon the analysis of the video data provided by camera 113a. Other embodiments may comprise other configurations of swivel mechanism 117 without deviating from the teachings disclosed herein. For example, some embodiments of swivel mechanism 117 may comprise a passive rotational element that is adjusted based upon the connection of towline 109 to towing attachment 111. In such an embodiment, swivel mechanism 117 may be configured such that camera 113a has a center-point of its field-of-view in alignment with towline 109. Thus, as surface rider 107 moves laterally with respect to watercraft 100 (i.e., along the port-starboard axis), towline 109 may cause adjustment of swivel mechanism 117 such that camera 113a remains substantially centered upon surface rider 107. Other embodiments may comprise other configurations without deviating from the teachings disclosed herein.

In the depicted embodiment, surface rider 107 may wear a tracking beacon 119 operable to provide an anomalous signal component to one or more of sensors 113, such that processor 115 may track the wristband within the surface-rider data. In the depicted embodiment, tracking beacon 119 may comprise a wristband composed of a bright, artificial color which contrasts sharply within the context of the video data captured by camera 113a. In the depicted embodiment, tracking beacon 119 may further comprise a radio frequency (RF) transmitter that generates an electro-magnetic transmission detectable by another of sensors 113 comprising an RF sensor. In some embodiments, tracking beacon 119 may comprise other forms of detectable signals instead of or in addition to the ones depicted herein. For example, in some embodiments tracking beacon 119 may further comprise an ultrasonic transmitter, an infrared transmitter, a thermal device, an RFID device, or any other motion-tracking device known to one of ordinary skill without deviating from the teachings disclosed herein.

In the depicted embodiment, tracking beacon 119 comprises a wristband, but other embodiments may comprise other configurations. In some embodiments, tracking beacon 119 may comprise alternative wearable configurations such as a necklace, headband, hat, anklet, wrist brace, arm brace, ankle brace, leg brace, belt, or any other wearable accessory operable to house a tracking beacon and known to one of ordinary skill in the art without deviating from the teachings herein. In some embodiments, tracking beacon 119 may be disposed within a piece of athletic equipment utilized by surface rider 107, such as a life vest, personal floatation device, swimsuit, wetsuit, dry-suit, face mask, goggles, helmet, swim cap, water ski, wakeboard, surfboard, hydroplane, disc, saucer, inner tube, or any other equipment suitable for a surface water sport and operable to house a tracking beacon known to one of ordinary skill in the art without deviating from the teachings disclosed herein.

In the depicted embodiment, camera 113a may comprise additional sensor elements operable to detect RF transmissions, and thus camera 113a may be operable to track a surface rider 107 utilizing RF transmissions generated by tracking beacon 119 in addition to visual data analysis.

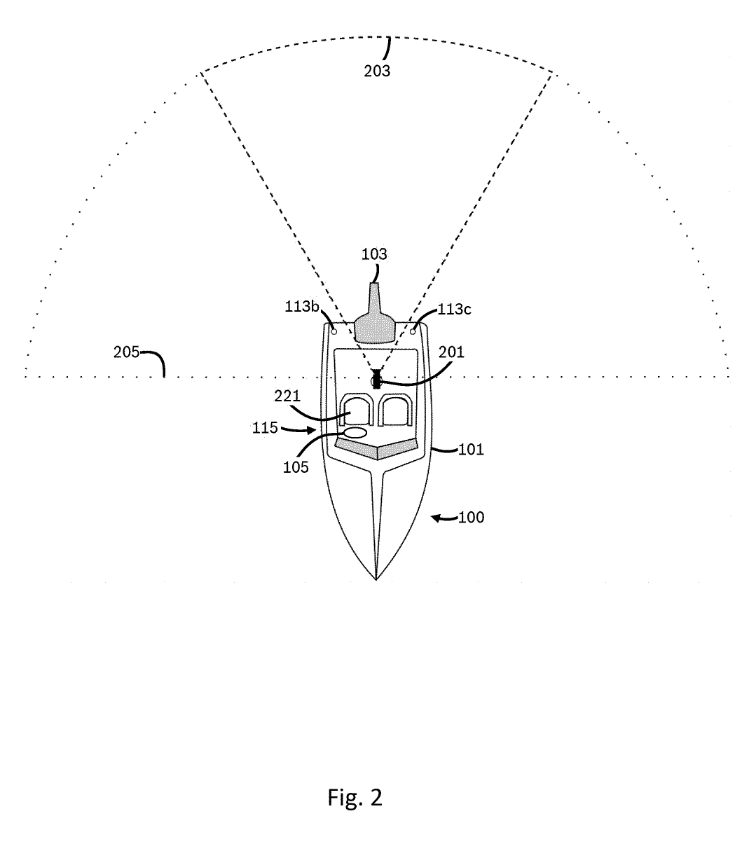

FIG. 2 provides a top-down diagrammatic illustration of a watercraft 100 having functions of the invention disclosed herein. A camera 113a and swivel mechanism 117 (see FIG. 1) are additionally represented in this illustration as a combined set of elements forming an adjustable camera apparatus 201. Adjustable camera apparatus 201 can be positioned to monitor a surface rider (see FIG. 1) within a range of visual acuity determined by the specification of the camera, and within a range of angles with respect to watercraft 100. Because a surface rider may generally be expected to be positioned on the waters astern of adjustable camera apparatus 201, the camera 113a is generally oriented astern of watercraft 100. In the depicted embodiment, adjustable camera apparatus 201 is actively oriented such that the field-of-view of camera 113a is centered on aquatic motor 103. The active field-of-view of camera 113a is illustrated using a dashed line, representing an active field-of-view 203. Active field-of-view 203 may be oriented as an angle of a complete potential field-of-view 205. Complete potential field-of-view 205 is illustrated using a dotted line, and represents the total possible angles from which camera 113a may operably collect data. Thus, so long as a surface rider 107 remains within the complete potential field-of-view 205 with respect camera 113a, the adjustable camera apparatus 201 may operably collect video data comprising the surface rider. In the depicted embodiment, the complete potential field-of-view 205 is defined by a substantially 180-degree arc, but other embodiments may comprise other configurations depending on the specifications of camera 113a and swivel mechanism 117. Some embodiments may comprise a lesser or greater complete potential field-of-view 205 corresponding to the specifications of camera 113a and swivel mechanism 117, such as a 360-degree arc. In the depicted embodiment, camera 113a may be operable to perform zoom functions to adjust the radius of the arc of the active field-of-view 203, but other embodiments may comprise other configurations without deviating from the teachings disclosed herein.

In the depicted embodiment, adjustable camera apparatus 201 may be operable to track a plurality of surface riders participating in tandem behind watercraft 100. Processor 115 may be configured to determine the positions of a plurality of tracking beacons 119 (see FIG. 1) corresponding to each of the surface riders, and center the active field-of-view 203 to accommodate all of the surface riders in their respective positions. In the depicted embodiment, processor 115 may be configured to center the active field-of-view 203 upon a weighted center-point between each of the plurality of surface riders, but other embodiments may comprise other configurations, such as prioritizing particular designated surface riders (e.g., maintaining active field-of-view 203 upon a less-experienced surface rider), maximizing the number of surface riders in the active field-of-view 203, or any other configuration known to one of ordinary skill in the art.

In the depicted embodiment, sensors 113 are more clearly depicted in relation watercraft 100. In the depicted embodiment, sensor 113b comprises an infrared sensor and sensor 113c comprises a lidar sensor, but other embodiments may comprise other configurations. Though the depicted embodiment comprises two distinct sensors 113 in addition to the camera 113a of adjustable camera apparatus 201, other embodiments may comprise a different number or configuration of sensors 113. Some embodiments may comprise configurations having a single sensor 113 and no camera 113a. Some embodiments may comprise a plurality of the same form of sensor 113. In some embodiments having a plurality of sensors 113, each of the sensors 113 may be operable to independently track a distinct surface rider within a group of surface riders.

The top-down view provided in FIG. 2 provides better clarity of the arrangement of helm controls 105 (see also FIG. 1). Helm controls 105 may additionally comprise a number of feedback indicators to provide the driver with indications of surface-rider data, such as metrics or special status conditions. Feedback indicators may generate visual, audible, or haptic stimulus in response to surface-rider data as analyzed by processor 115. For example, in the depicted embodiment, a feedback indicator may comprise a haptic seat 221 disposed within the seat of the driver when operating helm controls 105. Haptic seat 221 may be operable to vibrate the driver's seat in response to conditions determined by the analysis of surface-rider data. For example, a series of bursts of high vibration may be initiated in response to surface-rider data corresponding to a down condition of a surface rider. Other embodiments may comprise other haptic feedback without deviating from the teachings disclosed herein.

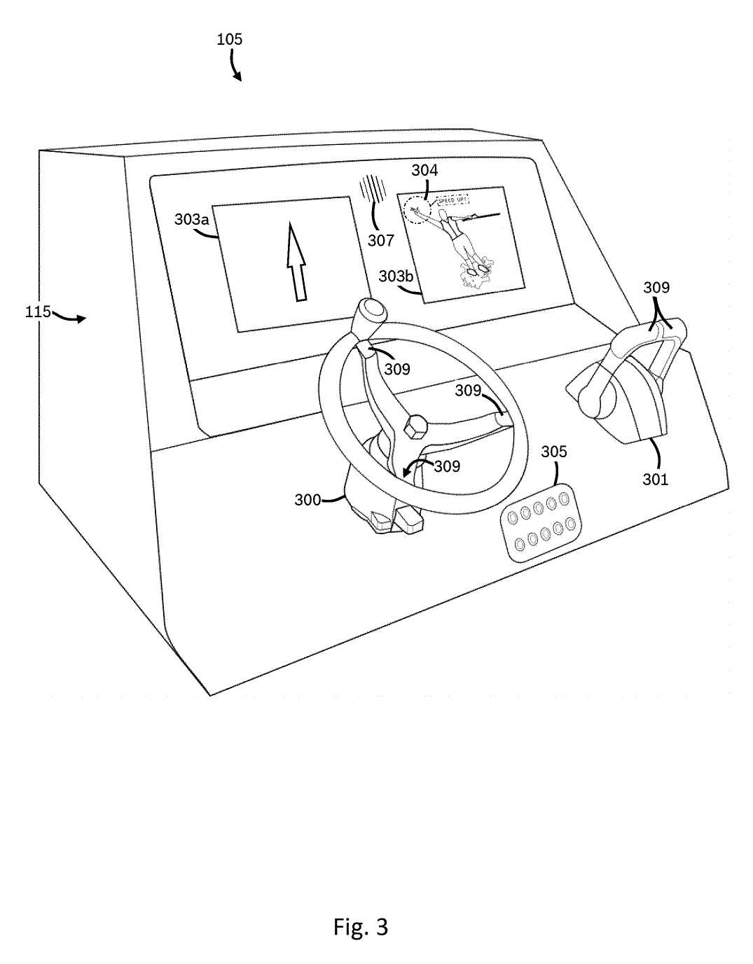

Other feedback indicators may be disposed within proximity to a driver's seat of watercraft 100 (see FIG. 1). FIG. 3 depicts one embodiment of helm controls 105 having a number of feedback indicators according to the teachings disclosed herein. Helm controls 105 comprise a steering wheel 300 and a throttle 301 operable to control motion and maneuvering of the watercraft. Helm controls 105 additionally comprise a number of displays 303. Displays 303 may be utilized for informational displays, such as vehicular metrics, navigation, or the like. Displays 303 may also be utilized as a visual feedback indicator for a driver while the watercraft provides support for a surface rider 107 (see FIG. 1). In the depicted embodiment, display 303b provides a real-time video feed of a surface rider using surface-rider data provided by a camera 113a (see FIG. 1) while display 303a remains operable to provide other useful data about the operation of the watercraft. In the depicted embodiment, displays 303 may be user-configurable to represent a user's preferred display options, but other embodiments may comprise other configurations without deviating from the teachings disclosed herein.

In the depicted embodiment, processor 115 is disposed within the console of helm controls 105, but other embodiments may comprise other arrangements without deviating from the teachings disclosed herein. Processor 115 may be operable to control displays 303 and provide a visual output representing the surface-rider data collected by sensors 113, or provide a visual feedback indication corresponding to the analysis of the surface-rider data by processor 115. Displays 303 may include both the raw video data captured by camera 113a, but also overlaid graphics 304 providing visual indicators of the status of surface rider correlating to the analysis of the surface-rider data analyzed by processor 115. In the depicted embodiment, overlaid graphics 304 comprise graphics indicating that the processor 115 has recognized a hand signal performed by the surface rider. In the depicted embodiment, the overlaid graphics 304 further comprise visual feedback providing the driver with the interpretation of the hand signal (e.g., directing the driver to increase speed of the watercraft).

In the depicted embodiment, displays 303 comprise a pair of displays housed within the console of helm controls 105, but other embodiments may comprise other configurations without deviating from the teachings disclosed herein. In some embodiments, displays 303 may be disposed in other parts of the watercraft 100, including other places disposed within hull 101, or mounted to hull 101. In some embodiments, displays 303 may be in wireless connection with processor 115 and disposed independent of the watercraft 100. In some embodiments, displays 303 may comprise the native displays of mobile processing devices, such as a tablet, portable computer, smart phone, or any other alternative device known to one of ordinary skill in the art without deviating from the teachings disclosed herein.

In the depicted embodiment, other forms of feedback indicators are provided for a driver of the watercraft. Additional visual feedback indicators are included in a bank of visual indicators 305. Visual indicators 305 comprise a number of color-changing lights having controllable color, intensity, and activity such that they are capable of providing a multitude of distinct indications having distinct color, brightness, or blinking patterns. Other embodiments may comprise a different arrangement of visual indicators having a different configuration without deviating from the teachings disclosed herein.

Processor 115 may also utilize an audible feedback indicator 307 to provide alternative forms of feedback to the driver. In the depicted embodiment, audible feedback indicator 307 comprises a loudspeaker disposed within the console of helm controls 105, the loudspeaker particularly disposed between displays 303. Other embodiments may comprise other arrangements of an audible feedback indicator 307. In some embodiments, a different number of audible feedback indicators 307 may be present. In some embodiments, audible feedback indicators 307 may be disposed in different locations with respect to watercraft 100 in addition to or instead of within the console of helm controls 105. In some embodiments, audible feedback indicators may comprise a number of speakers in wireless connection with processor 115 that may be mobile with respect to watercraft 100. In some embodiments, audible feedback indicators may comprise audible outputs of mobile processing devices, such as a tablet, portable computer, smart phone, or any other alternative device known to one of ordinary skill in the art without deviating from the teachings disclosed herein.

Audible feedback provided by the audible feedback indicator 307 may comprise predetermined alarms, sound effects, klaxons, verbal prompts, or any other sound or combination of sounds known to one of ordinary skill in the art to correlate to surface-rider data without deviating from the teachings disclosed herein. In the depicted example embodiment, a verbal prompt may be provided in tandem with the visual feedback of display 303b indicating that the surface rider has requested that the driver increase the speed of the watercraft. Thus, audible feedback indicator 307 will output an audible verbal prompt of “Speed up” to the driver. Other common prompts (e.g., “Rider down,” “Slow down”, etc.) may be utilized in response to the appropriate conditions indicated by surface-rider data analysis.

Helm controls 105 may further comprise a number of haptic feedback indicators 309. Haptic feedback indicators 309 may be controlled by processor 115 to provide haptic feedback to the driver corresponding to the surface-rider data or the analysis of the surface-rider data by processor 115. Haptic feedback indicators 309 may vibrate with a predetermined pattern and intensity in response to various status conditions of surface rider 107 (see FIG. 1). In the depicted embodiment, haptics feedback indicators 309 operate in tandem with haptic seat 221 (see FIG. 2), but other embodiments may comprise other configurations without deviating from the teachings disclosed herein. In the depicted embodiment, haptic feedback indicators 309 are disposed upon the steering wheel 300 and throttle 301 to advantageously maximize the chances that the driver will be receptive haptic feedback while driving the watercraft. Other embodiments may comprise other or additional haptic feedback indicators disposed at other parts of watercraft 100 without deviating from the teachings disclosed herein. Other embodiments may comprise haptic feedback indicators that are mobile with respect to watercraft 100. In such embodiments, haptic feedback indicators may comprise wearable devices such as a wristband, necklace, headband, hat, anklet, wrist brace, arm brace, ankle brace, leg brace, belt, or any other wearable accessory operable to house a haptic element and known to one of ordinary skill in the art without deviating from the teachings herein. In some embodiments, a haptic feedback indicator 309 may be disposed within a piece of athletic equipment utilized by a passenger of the watercraft 100 (see FIG. 1) such as a life vest, personal floatation device, swimsuit, wetsuit, dry-suit, face mask, goggles, helmet, swim cap, or any other equipment suitable for a surface water sport and operable to house a tracking beacon known to one of ordinary skill in the art without deviating from the teachings disclosed herein. In some embodiments, haptic feedback indicators 309 may be disposed within the tracking beacon 119 of a surface rider 107 (see FIG. 1), and may be utilized by operating the tracking beacon 119 in a different mode. In some embodiments, haptic feedback indicators 309 may comprise vibrating or electro-motor elements of mobile processing devices, such as a tablet, portable computer, smart phone, or any other alternative device known to one of ordinary skill in the art without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A surface-rider monitoring system operable to monitor a surface rider in waters astern of the bow of a motorized watercraft, the system comprising:
a number of sensors disposed within a proximity to the hull of the watercraft, the number of sensors comprising a camera and at least one other sensor, the sensors being operable to monitor the waters astern of the bow of the watercraft during motion and to generate corresponding surface-rider data;
a processor in data communication with the number of sensors, the processor operable to receive surface-rider data from the number of sensors and generate rider-status data indicating a status of a surface rider traversing the waters astern of the bow of the watercraft; and
a plurality of feedback indicators in data communication with the processor, the plurality of feedback indicators operable to provide indication of the rider-status data, the plurality of feedback indicators comprising a display and at least one of a visual indicator, an audible indicator, or a haptic indicator.

2. The surface-rider monitor system of claim 1, the number of sensors comprising at least one of an optical sensor, an infrared sensor, an ultraviolet sensor, a radar sensor, a lidar sensor, a laser sensor, an ultrasound sensor, a tension sensor, or a load sensor.

3. The surface-rider monitor system of claim 2, wherein the number of sensors further comprises an infrared sensor.

4. The surface-rider monitor system of claim 2, wherein the number of sensors comprises at least two different types of sensors selected from a group comprising of an optical sensor, an infrared sensor, an ultraviolet sensor, a radar sensor, a lidar sensor, a laser sensor, a sonic sensor, an ultrasound sensor, a tension sensor, and a load sensor.

5. The surface-rider monitor system of claim 1, wherein the number of sensors are operable to detect a number of pre-determined hand signals performed by the rider and the processor is further operable to interpret the hand signals when generating rider-status data.

6. The surface-rider monitor system of claim 1, wherein the display is disposed within an ergonomic proximity of the helm controls of the watercraft.

7. The surface-rider monitor system of claim 1, wherein the plurality of feedback indicators comprises a haptic indicator.

8. The surface-rider monitor system of claim 7, wherein the haptic indicator is disposed within the helm controls of the watercraft.

9. The surface-rider monitor system of claim 7, wherein the haptic indicator is disposed within a seat positioned within ergonomic proximity of the helm controls of the watercraft.

10. The surface-rider monitor system of claim 1, the camera further being operable to perform motion-tracking of a surface-rider.

11. The surface-rider monitor system of claim 10, wherein the camera is operable to track a radio frequency (RF) transmitter worn by the surface rider during the motion-tracking of the surface rider.

12. The surface-rider monitor system of claim 10, wherein the camera is operable to track a plurality of surface riders, the camera being operable to center its field-of-view upon a center-point between the plurality of surface riders.

13. A motorized watercraft operable to support a surface rider traversing the surface of the waters astern of the bow of the watercraft, the watercraft comprising:
a hull;
an aquatic motor operably coupled to a portion of the hull and operable to propel the watercraft when the aquatic motor is at least partially disposed within the water;
a helm operably coupled to the hull, the helm operable to steer the hull toward a desired direction when the hull is propelled by the aquatic motor;
a number of sensors disposed within a first proximity to the hull and comprising a camera and at least one other sensor, the number of sensors being operable to monitor the waters astern of the bow of the watercraft during motion and generate corresponding surface-rider data;
a processor in data communication with the plurality of sensors, the processor operable to receive surface-rider data from the number of sensors and generate rider-status data indicating a status of a surface rider traversing the waters astern of the bow of the watercraft; and
a plurality of feedback indicators disposed within a second proximity to the hull and in data communication with the processor, the plurality of feedback indicators operable to provide indication of the rider-status data, the plurality of feedback indicators comprising a display disposed within a third proximity to the helm and at least one of a visual indicator, an audible indicator, or a haptic indicator.

14. The motorized watercraft of claim 13, further comprising a towing attachment comprising a towing hitch or a towing pylon, the towing attachment operably coupled to the hull of the watercraft, and a towline operably connected to the towing attachment and operable to tow the surface rider when the watercraft is in motion.

15. The motorized watercraft claim of 14, wherein the camera is mounted upon an adjustable-angle camera mount operably coupled to the towline such that the field-of-view of the camera remains centered upon the towline as it extends away from the watercraft when towing the surface rider.

16. The motorized watercraft of claim 15, wherein the adjustable-angle camera mount is operable to adjust the field-of-view of the camera at least along a 180-degree arc in a direction astern of the towing attachment.

17. A surface-rider monitoring system operable to monitor a surface rider in waters astern of the bow of a motorized watercraft, the system comprising:
a number of sensors disposed within a proximity to the hull of the watercraft, the number of sensors being operable to monitor the waters astern of the bow of the watercraft during motion and to generate corresponding surface-rider data;
a processor in data communication with the number of sensors, the processor operable to receive surface-rider data from the number of sensors and generate rider-status data indicating a status of a surface rider traversing the waters astern of the bow of the watercraft; and
a plurality of feedback indicators in data communication with the processor, the plurality of feedback indicators operable to provide indication of the rider-status data, the plurality of feedback indicators comprising at least a display.
